(19) United States
(12) Patent Application Publication
(10) Pub. No.: US 2018/0016922 A1
(43) Pub. Date: Jan. 18, 2018

(54) Transition Duct Support Arrangement for a Gas Turbine Engine

(71) Applicant: Siemens Energy, Inc., Orlando, FL (US)

(72) Inventor: Anthony L. Schiavo, Oviedo, FL (US)

(21) Appl. No.: 15/208,219

(22) Filed: Jul. 12, 2016

(51) Int. Cl. F01D 9/02; F23R 3/42; F23R 3/60; F23R 3/48

(52) U.S. Cl. CPC F01D 9/023; F23R 3/48; F23R 3/425; F23R 3/60; F05D 2240/40; F05D 2250/141; F23R 2900/00005

(57) ABSTRACT

A gas turbine engine has a crown locking device and a seal portion. The crown locking device and seal portion connect a transition duct to an inlet extension piece. The crown locking device and seal portion is located between a metallic integrated exit piece and a transition duct that is made of ceramic matrix composites.

### STATEMENT REGARDING FEDERALLY SPONSORED DEVELOPMENT

This invention was made with government support under Program DE-FE0023955, awarded by the United States Department of Energy. The government has certain rights in the invention.

### BACKGROUND

### 1. Field

Disclosed embodiments are generally related to gas turbine engines and, more particularly to the transition system used in gas turbine engines.

### 2. Description of the Related Art

A gas turbine engine typically has a compressor section, a combustion section having a number of combustors and a turbine section. Ambient air is compressed in the compressor section and conveyed to the combustors in the combustion section. The combustors combine the compressed air with a fuel and ignite the mixture creating combustion products. The combustion products flow in a turbulent manner and at a high velocity. The combustion products are routed to the turbine section via transition ducts. Within the turbine section are rows of vane assemblies. Rotating blade assemblies are coupled to a turbine rotor. As the combustion product expands through the turbine section, the combustion product causes the blade assemblies and turbine rotor to rotate. The turbine rotor may be linked to an electric generator and used to generate electricity.

During the operation of gas turbine engines strong forces are generated that can impact the structure of the gas turbine engine. These forces may occur in the transition duct. Accommodating these forces to avoid breakage is important for the continued operation of the gas turbine engine.

### SUMMARY

Briefly described, aspects of the present disclosure relate to the transition system of a gas turbine engine.

An aspect of the disclosure may be a gas turbine engine having a combustor basket. The gas turbine engine may also have a transition duct connected to the combustor basket, wherein the transition duct has a spherical crown portion forming a curved surface and a receiving slot formed in the curved surface, wherein the crown portion is located downstream from the combustor basket; a tapered support piece surrounding the transition duct; a crown locking device seated in the receiving slot, wherein the crown locking device connects the tapered support piece and the transition duct; an inlet extension piece connected to the transition duct; and a seal portion located between the inlet extension piece and the transition duct adapted for accommodating thermal deformations during operation of the gas turbine engine.

Another aspect of the present disclosure may be an assembly for connecting a transition duct to an inlet extension piece in a gas turbine engine having a receiving slot formed in a curved surface of a spherical crown portion of a transition duct, a crown locking device having a first leg and a second leg, wherein the first leg and the second leg are received in the receiving slot, wherein the first leg extends in a downstream direction in the receiving slot and the second leg extends in an upstream direction in the receiving slot; and a seal portion adapted for accommodating thermal deformations during operation of the gas turbine engine, wherein the seal portion is located downstream of the crown locking device and connects an inlet extension piece to the transition duct.

Still another aspect of the present disclosure may be a gas turbine engine having a combustor basket. The gas turbine engine may also have a transition duct connected to the combustor basket, wherein the transition duct has a spherical crown portion forming a curved surface and a receiving slot formed in the curved surface, wherein the crown portion is located downstream from the combustor basket; a seal locking piece comprising; a seal locking piece insert seated in the receiving slot, and a seal locking piece seal located between an inlet extension piece and the transition duct adapted for accommodating thermal deformations during operation of the gas turbine engine.

### BRIEF DESCRIPTION OF THE DRAWINGS

FIG. 1 shows a view of the transition system in a gas turbine engine.

FIG. 2 is a cross-sectional view of the transition system in a gas turbine engine.

FIG. 3 is a close up view of a seal portion and crown locking device.

FIG. 4 is a view of the seal portion and crown locking device illustrating the spherical curve.

FIG. 5 is another view of the seal portion and crown locking device connected to a tapered support piece.

FIG. 6 is another view of the seal portion and crown locking device illustrating the connection between the transition duct and inlet extension piece.

FIG. 7 shows a seal locking device.

### DETAILED DESCRIPTION

To facilitate an understanding of embodiments, principles, and features of the present disclosure, they are explained hereinafter with reference to implementation in illustrative embodiments. Embodiments of the present disclosure, however, are not limited to use in the described systems or methods.

The components and materials described hereinafter as making up the various embodiments are intended to be illustrative and not restrictive. Many suitable components and materials that would perform the same or a similar function as the materials described herein are intended to be embraced within the scope of embodiments of the present disclosure.

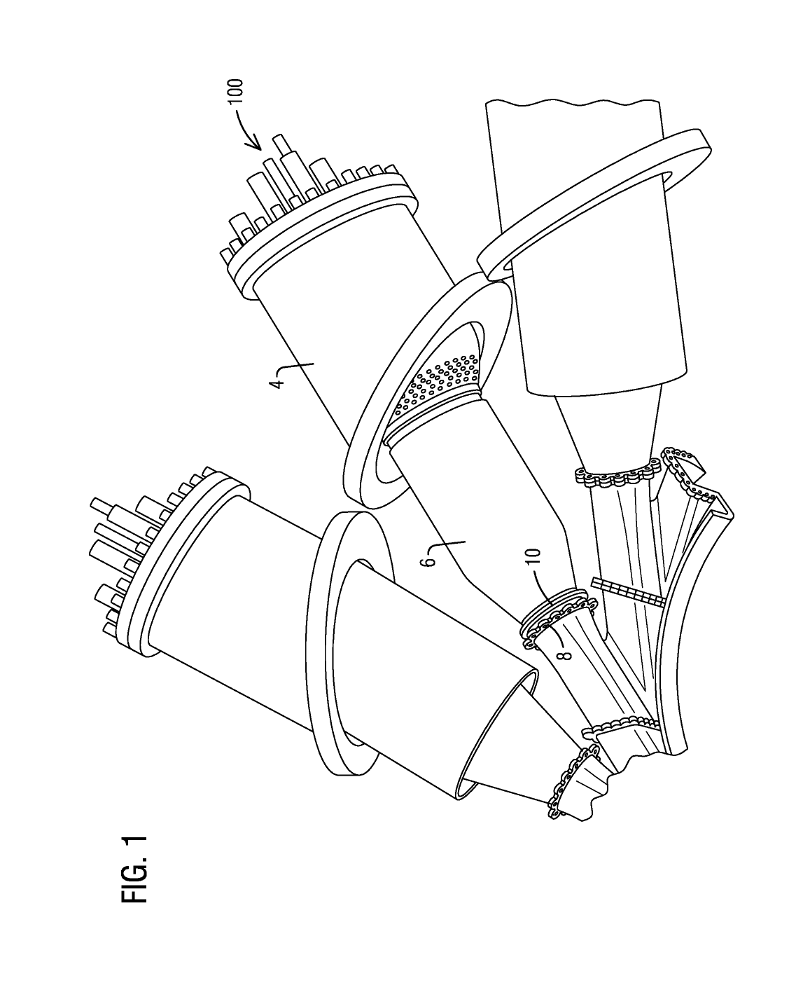

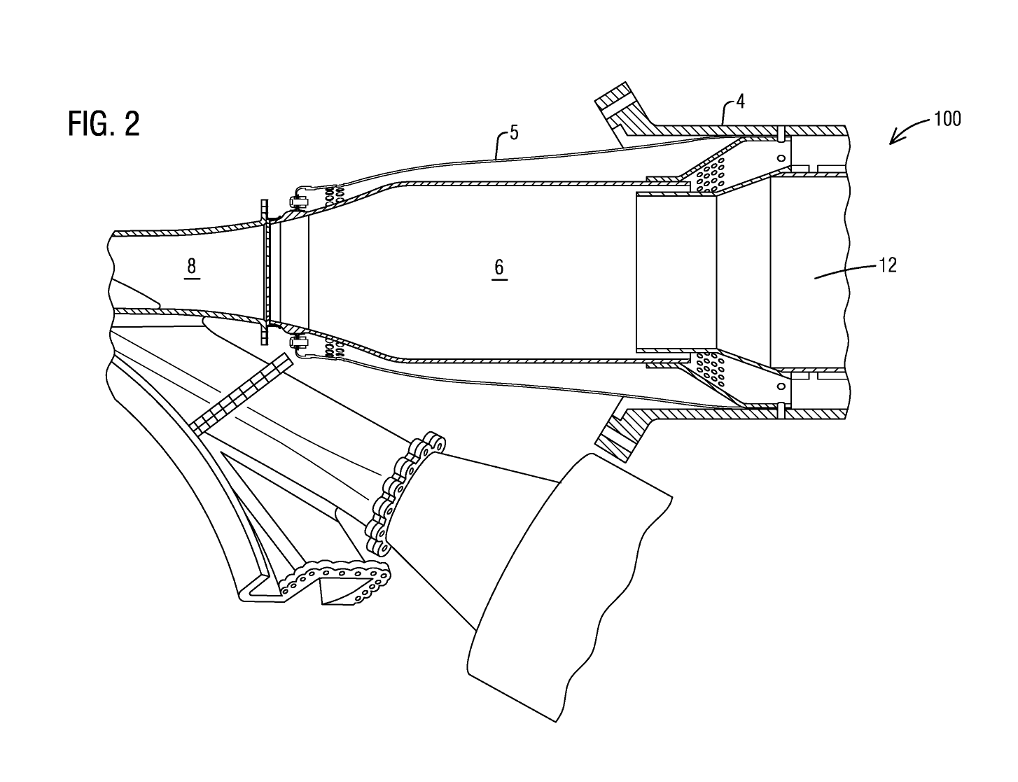

FIGS. 1 and 2 show a view of a transition system in a gas turbine engine 100. Shown is the spool piece 4 which surrounds and supports the combustor basket 12. Also shown is the transition duct 6 connected to the combustor basket 12 at the upstream end of the transition duct 6. The integrated exit piece (IEP) 8 is connected to the downstream end of the transition duct 6. Shown in FIG. 2 is a tapered support piece 5 that surrounds the transition duct 6. The tapered support piece 5 is tapered to assist with the flow of air in the combustion mid-frame. The tapered support piece 5 is tapered so that when placed in an array it does not collide with other components of the gas turbine engine 100. In the embodiment shown the IEP 8 is made of metallic material while the transition duct 6 is made of ceramic matrix composites (CMC). The use of the CMC material for the transition duct 6 while having a metallic IEP 8 encourages use of the transition duct supporter 10 in order to accommodate the different responses the materials have to thermal changes that occur during operation of the gas turbine engine 100.

Working gases flow downstream from the combustor basket 12 in an axial direction through the transition duct 6 and then the IEP 8. The flow of the working gases from the combustor basket 12 can cause thermal deformations in the connections between the components of the gas turbine engine 100. The tapered support piece 5 surrounding the transition duct 6 is able to facilitate the flow of air through the transition system and assist in controlling the temperatures that occur during the operation of the gas turbine engine 100. The tapered support piece 5 is tapered to follow the contour of the transition duct 6 in areas of operational high heat flux. The tapered support piece 5 may have metering holes 7 that can regulate the axial location and flow quality of supply air into the combustion basket. The metering holes 7 are arranged to target locations and allow cooling air impingement onto the transition duct 6.

The tapered support piece 5 has a slope of to assist with the flow of air and to avoid collision with adjacent components of the gas turbine engine 100. The slope of the tapered support piece 5 may be between 5-10 degrees, and in the embodiment shown is approximately 7 degrees and is defined by the diameter of the outer casing combustion portal and the diameter of the exit of the transition duct 6. The tapered support piece 5 braces the exit end of the transition duct 6 during installation and removal. Further, the tapered support piece 5 structurally supports the exit of the transition duct 6 during engine operation. The tapered support piece 5 also reduces the aerodynamic blockage in the combustion mid frame

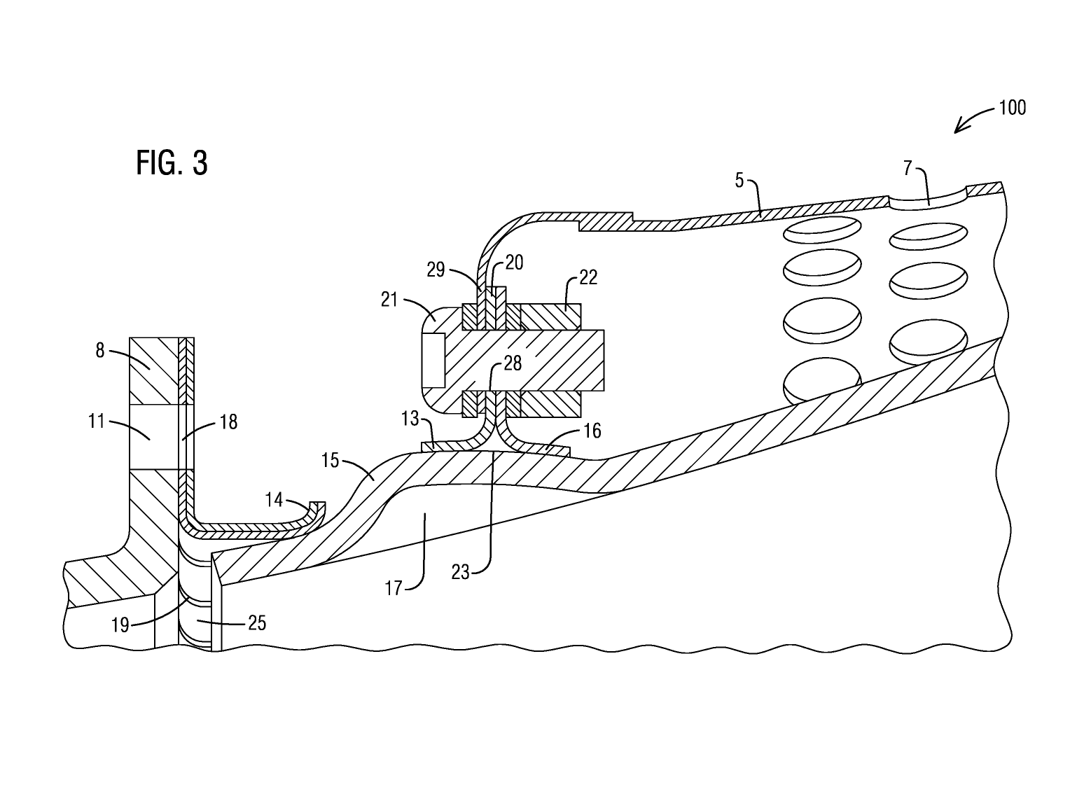

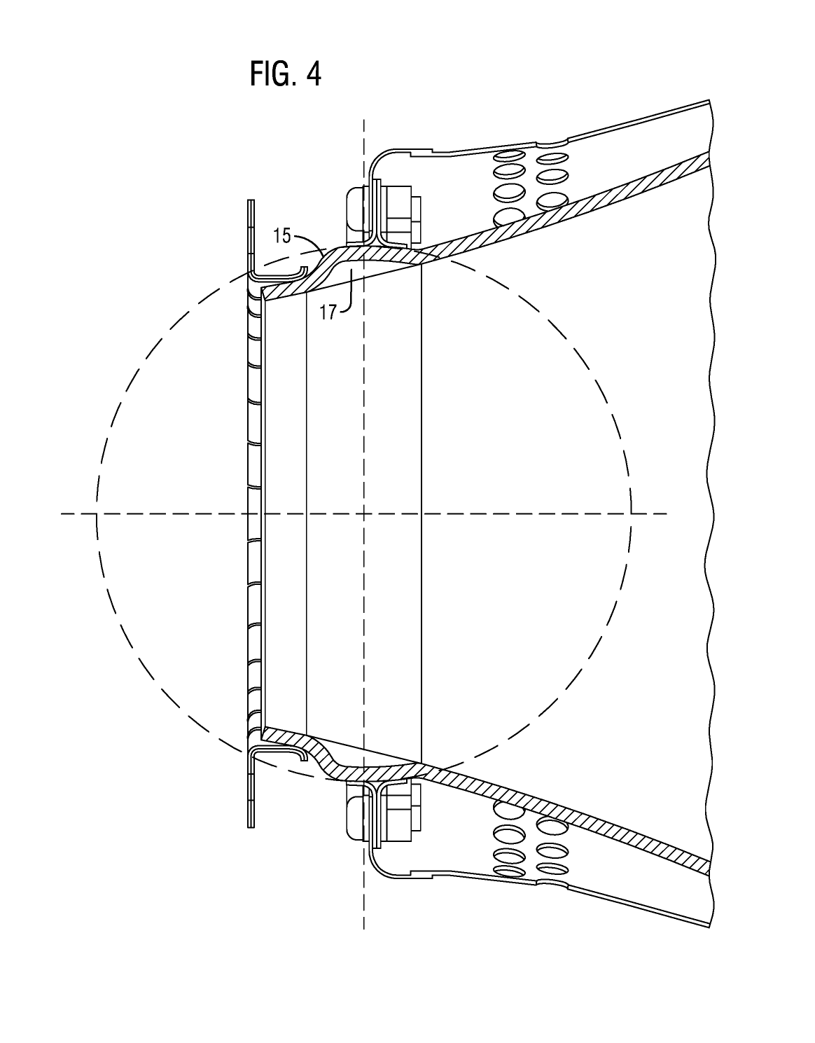

FIG. 3 is a cross-sectional view of the transition system of the gas turbine engine 100. The transition duct 6 has a spherical crown portion 17 that has a curved surface 15. The curved surface 15 has a curve that when extended would form a spherical surface whose center would be coincidence with the centreline of the combustion system. This is shown diagrammatically in FIG. 4. The curved surface 15 may be formed by CMC fiber layers. Forming the curved surface 15 with CMC fiber layers helps maintain the structural integrity of the spherical crown portion 17 despite wear and tear that may occur due to thermal deformation. The CMC fibers may be worn away without causing failure to the integrity of the transition duct 6. Formed within the curved surface 15 is a receiving slot 23.

Connecting the tapered support piece 5 to the downstream end of the transition duct 6 is the crown locking device 20. The tapered support piece 5 has formed therein bolt holes 28. The bolt holes 28 are sized and shaped to receive bolts 21. The crown locking devices 20 also have formed therein bolt holes 29. Bolts 21 are placed through the bolt holes 28 and the bolt holes 29. Nuts 22 secure the bolts 21 in place. It should be understood that connection of the tapered support piece 5 to the transition duct 6 may be accomplished by other methods such as screws, brazing, welding, castings, etc.

The crown locking device 20 has a first leg 13 and a second leg 16. The first leg 13 extends radially towards the axis and then curves in a downstream direction and extends in a downstream direction when placed in the receiving slot 23. This forms a substantially L shape when viewed in cross-section. The second leg 16 extends radially towards the axis and then extends in an upstream direction when placed in the receiving slot 23. The first leg 13 and the second leg 16 are secured in place by radially directed pressure. The first leg 13 and the second leg 16 are sized and shaped so that together they substantially fill the space of the receiving slot 23. The pressure fit of the crown locking device 20 is able to accommodate the thermal deformation that occurs during the operation of the gas turbine engine 100 without becoming unsecured or damaged. The crown locking device 20 is also able to accommodate swivelling of the transition duct 6 and can facilitate installation of the transition duct 6 without the need for installers to enter into the components.

Located downstream of the crown locking device 20 is the seal portion 25. The seal portion 25 has bolt holes 18 and flex slots 19 formed therein. The seal portion 25 is secured to the IEP 8 via bolts (not shown) placed through bolt holes 11 in the IEP 8 and through the bolt holes 18 in the seal portion 25. The seal portion extends radially towards the axis of the transition duct 6 and then extends axially in an upstream direction and abuts the surface of the transition duct 6. The seal portion 25 generally forms an L shape when viewed in cross section. During operation of the gas turbine engine 100 the thermal deformations that occur and general movement of the components is accommodated by the seal portion 25. Axial upstream movement of seal portion 25 is prevented when seal portion barrier 14 comes into contact with the curved portion 15 of the spherical crown portion 17.

The seal portion 25 further has flex slots 19 formed therein. The flex slots 19 are formed on the surface of the seal portion 25 that faces the interior of the IEP 8 and the transition duct 6. The flex slots 19 can be formed at regular intervals around the seal portion 25. During operation of the gas turbine engine 100 the flex slots 19 permit the seal portion 25 to accommodate thermal deformation and thereby foster stronger structural integrity.

FIG. 4 shows the connection of the seal portions 25 and the crown locking devices 20 to the tapered support piece 5 and the transition duct 6. From this view it can be seen that the crown locking devices 20 extend circumferentially around the transition duct 6. Each crown locking device 20 extends along an arc of no greater than 180 degrees and no less than 5 degrees.

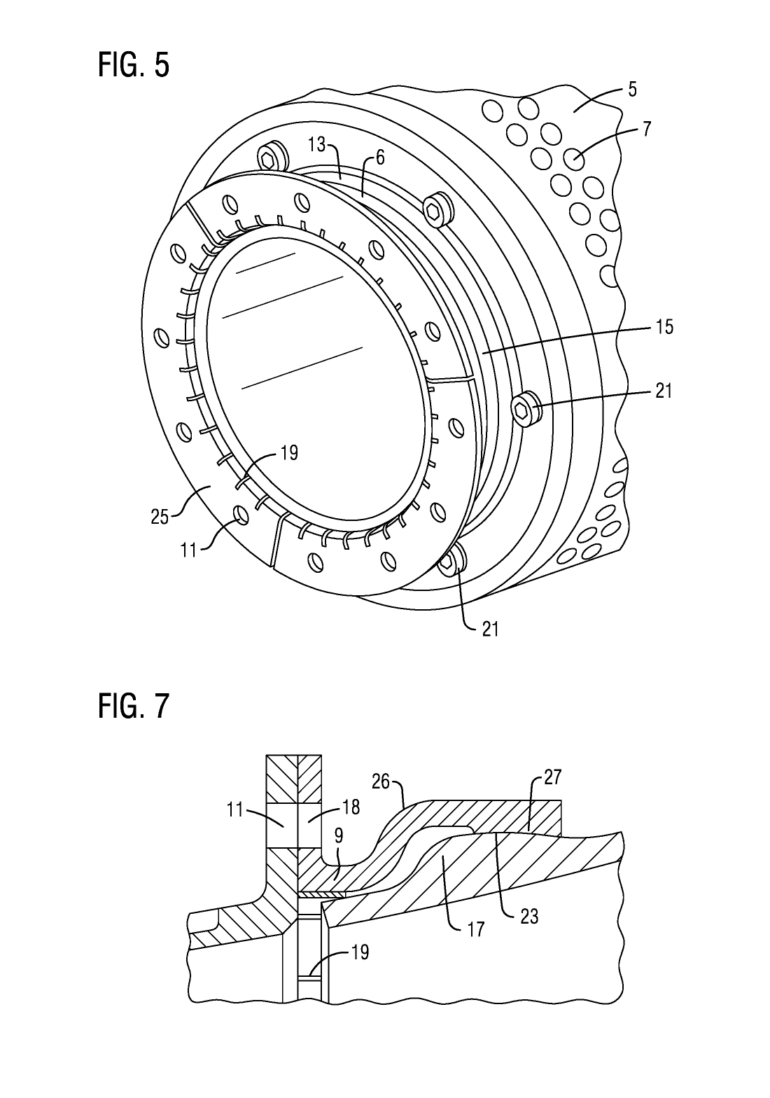

FIG. 5 shows another view of the crown locking devices 20 connected to the tapered support piece 5 and the transition duct 6. Also shown is the seal portion 25 connected to the IEP 8.

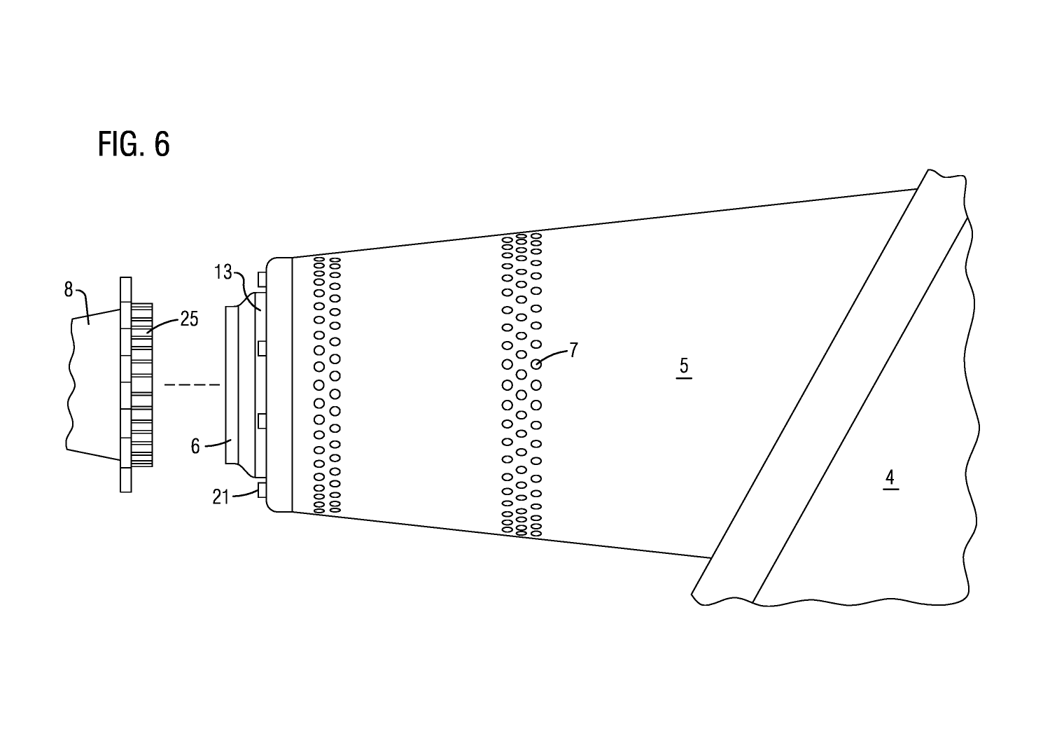

FIG. 6 shows an alternative embodiment wherein there is a seal locking piece 26. The seal locking piece 26 has seal locking piece insert 27 and a seal locking piece seal 9. The seal locking piece insert 27 is sized to be fitted into the receiving slot 23 so that the seal locking piece 26 is secured in the spherical crown portion 17. The seal locking piece 26 extends downwardly into the receiving slot 23. The receiving slot 23 is sized to receive the seal locking piece insert 27. The seal locking piece 26 curves radially downward and extends in a downstream direction when securing the transition duct 6 to the IEP 8. The seal locking piece seal 9 is flush against the IEP 8 and seals the gap formed between the IEP 8 and the transition duct 6. The seal locking piece 26 is able to both secure the transition duct 6 to the IEP 8 and seal the gap while being able to spherically swivel and accommodate the thermal displacements that occur during the operation of the gas turbine engine 100.

The seal locking piece seal 9 may also have flex slots 19 formed on the surface of the seal locking piece seal 9 that faces the interior of the IEP 8 and the transition duct 6. During operation of the gas turbine engine 100 the flex slots 19 permit the seal locking piece seal 9 to accommodate thermal deformation and thereby foster stronger structural integrity.

While embodiments of the present disclosure have been disclosed in exemplary forms, it will be apparent to those skilled in the art that many modifications, additions, and deletions can be made therein without departing from the spirit and scope of the invention and its equivalents, as set forth in the following claims.

What is claimed is:

1. A gas turbine engine comprising:
a combustor basket
a transition duct connected to the combustor basket, wherein the transition duct has a spherical crown portion forming a curved surface and a receiving slot formed in the curved surface, wherein the crown portion is located downstream from the combustor basket;
a tapered support piece surrounding the transition duct;
a crown locking device seated in the receiving slot, wherein the crown locking device connects the tapered support piece and the transition duct;
an inlet extension piece connected to the transition duct; and
a seal portion located between the inlet extension piece and the transition duct adapted for accommodating thermal deformations during operation of the gas turbine engine.

2. The gas turbine engine of claim 1, wherein the spherical crown portion is formed from continuous fiber.

3. The gas turbine engine of claim 1, wherein the transition duct is made of ceramic matrix composites.

4. The gas turbine engine of claim 1, wherein the inlet extension piece is made of metal.

5. The gas turbine engine of claim 1, wherein the crown locking device is one of a plurality of crown locking devices.

6. The gas turbine engine of claim 1, wherein the seal portion has a plurality of flex slots.

7. The gas turbine engine of claim 1, wherein the seal portion is one of a plurality of seal portions.

8. The gas turbine engine of claim 1, wherein the seal portion has a generally L shaped cross-section.

9. The gas turbine engine of claim 1, wherein the tapered support piece has metering holes formed therein.

10. An assembly for connecting a transition duct to an inlet extension piece in a gas turbine engine comprising:
a receiving slot formed in a curved surface of a spherical crown portion of a transition duct,
a crown locking device having a first leg and a second leg, wherein the first leg and the second leg are received in the receiving slot, wherein the first leg extends in a downstream direction in the receiving slot and the second leg extends in an upstream direction in the receiving slot; and
a seal portion adapted for accommodating thermal deformations during operation of the gas turbine engine, wherein the seal portion is located downstream of the crown locking device and connects an inlet extension piece to the transition duct.

11. The assembly of claim 10, wherein the spherical crown portion is formed from continuous fiber.

12. The assembly of claim 10, wherein the transition duct is made of ceramic matrix composites.

13. The assembly of claim 12, wherein the inlet extension piece is made of metal.

14. The assembly of claim 10, wherein the crown locking device is one of a plurality of crown locking devices.

15. The assembly of claim 10, wherein the seal portion has a plurality of flex slots.

16. The assembly of claim 10, wherein the seal portion is one of a plurality of seal portions.

17. The assembly of claim 10, wherein the seal portion has a generally L shaped cross-section.

18. A gas turbine engine comprising:
a combustor basket
a transition duct connected to the combustor basket, wherein the transition duct has a spherical crown portion forming a curved surface and a receiving slot formed in the curved surface, wherein the crown portion is located downstream from the combustor basket;
a seal locking piece comprising;
a seal locking piece insert seated in the receiving slot, and
a seal locking piece seal located between an inlet extension piece and the transition duct adapted for accommodating thermal deformations during operation of the gas turbine engine.

19. The gas turbine engine of claim 18, wherein the crown locking device is one of a plurality of crown locking devices.

20. The gas turbine engine of claim 18, wherein the seal portion has a plurality of flex slots.
